(19) United States
(12) Patent Application Publication
(10) Pub. No.: US 2006/0205288 A1
(43) Pub. Date: Sep. 14, 2006

(54) Contact for electrical connector

(75) Inventor: Yuan-Chien Chung, Tu-Cheng (TW)

Correspondence Address: WEI TE CHUNG;FOXCONN INTERNATIONAL, INC., 1650 MEMOREX DRIVE, SANTA CLARA, CA, 95050, US

(73) Assignee: HON HAI PRECISION IND. CO., LTD.

(21) Appl. No.: 11/218,768

(22) Filed: Sep. 2, 2005

(30) Foreign Application Priority Data
Mar. 10, 2005 (CN) 200510038429.0

(51) Int. Cl. H01R 4/48

(52) U.S. Cl. 439/862

(57) ABSTRACT

A contact (10) for an electrical connector mounted on a PCB and engaging with a cylindrical plug pin (100) includes a base portion (11) having a number of barbs (112), a tail portion (13) and a contacting portion (12). The contacting portion extends from the base portion, and has a resilient portion (121) thereof. The resilient portion forms a curved portion (125) along a transversal direction thereof. The curved portion partially embrace the plug pin along an arc-shaped line. Therefore, the contact has a large engaging area, and the retention force between the contact and the plug pin is increased.

### BACKGROUND OF THE INVENTION

1. Field of the Invention

The present invention generally relates to a contact for an electrical connector, and particularly relates to a contact mating a cylindrical plug pin.

2. Description of Prior Arts

Receptacle connector is widely used in the electric industry with electrical contacts received therein connecting a printed circuited board (PCB) to achieve signals transferred between the PCB and a plug connector. When the plug connector is completely engaged with the receptacle connector, retention force between the two mating contacts of the plug and receptacle connectors is an important factor to assure steady signal transfer.

U.S. Pat. No. 5,927,999 discloses a power jack having three conductive contacts 23, 24, 25 which are all plane-shaped. Each contact forms an outward bent to resiliently engage a mating plug pin. However, the contacts engage the mating plug pin and implement a three-point contact therebetween. Obviously, the contact area is so small that the retention force between the mated contacts is not enough to hold the mating plug pin. The reliable electrical connection could not be ensured.

Hence, an improved contact is required to overcome the aforesaid disadvantages of the prior art.

### SUMMARY OF THE INVENTION

It is an object of the present invention to provide a contact for an electrical connector having a large contact area with great retention force to a cylindrical plug pin.

In order to achieve the above-mentioned object, a contact for an electrical connector mounted on a PCB and engaging with a cylindrical plug pin includes a base portion having a plurality of barbs thereon, a tail portion contacting the PCB and a contacting portion. The contacting portion extends from the base portion, and has a resilient portion thereof. The resilient portion forms a curved portion along a transversal direction thereof, adapted for partially embrace the plug pin along an arc-shaped line.

Other objects, advantages and novel features of the invention will become more apparent from the following detailed description of the present embodiment when taken in conjunction with the accompanying drawings.

### BRIEF DESCRIPTION OF THE DRAWING

FIG. 1 is a perspective view of a contact in accordance with one embodiment of the present invention;

FIG. 2 is a view similar to FIG. 1, but taken from another perspective;

FIG. 3 is a side view showing the cylindrical plug pin and the contact completely engaging with each other;

FIG. 4 is a cross-sectional view taken along line 6-6 of FIG. 3.

### DETAILED DESCRIPTION OF THE PREFERRED EMBODIMENT

Reference will now be made to the drawing figures to describe the present invention in detail.

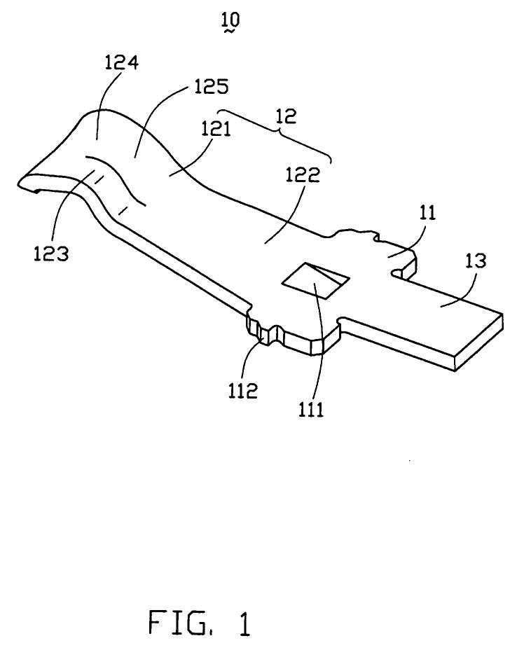

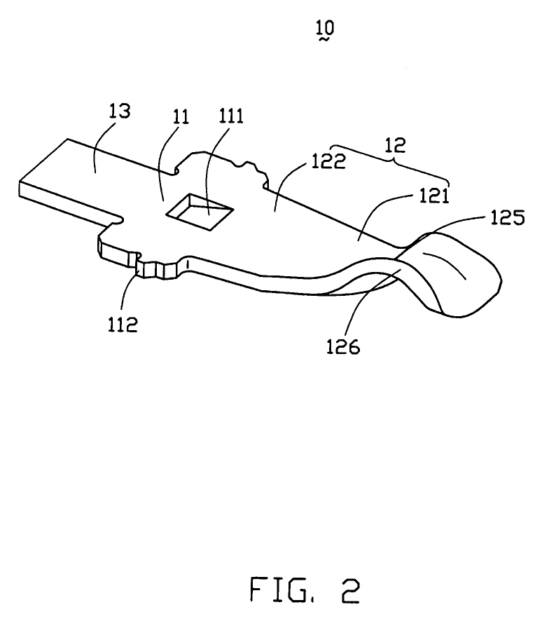

With reference to FIGS. 1-2, a contact 10 for an electrical connector (not shown) in accordance with one embodiment of the present invention comprises a base portion 11, a tail portion 13 extending from one side of the base portion 11 to contact a PCB and a contacting portion 12 prolonging from another side of the base portion 11. The base portion 11 is approximately rectangular and plane-shaped, wherein a plurality of barbs 112 are formed at its two opposite sides to retain the contact 10 in the connector. A retaining tab 111 is punched from the center and with a sharp angle relative to the plane of the base portion 11, to engage with an insulative housing (not shown) of the connector to retain the contact 10 therein.

Referring to FIGS. 1-2, the contacting portion 12 comprises a resilient portion 121 and a connecting portion 122. The connecting portion 122 extends from the last side of base portion 11 and connects to resilient portion 121, which is with the same plane of the base portion 11 and can be shorter or longer in different embodiment. The resilient portion 121 forms a curved portion 125 at the front end thereof whose gradient is quite smooth. Referring to FIG. 1, the curved portion 121 is formed of two parts 123, 124 in a transversal direction. The first part 123 is narrower than the second part 124. They are stamped with one piece of metal and both bent in the longitudinal direction to form aforementioned curved portion 125. Referring to FIG. 2, the curved portion 125 of the second part 124 further bent outwardly to form an arc-shaped portion 126 as a converted saddle.

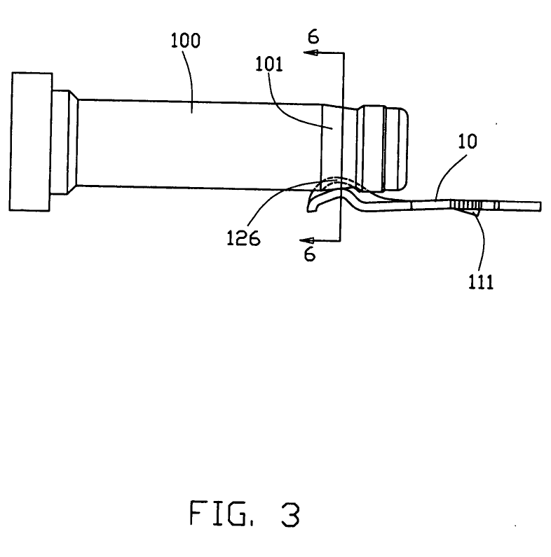

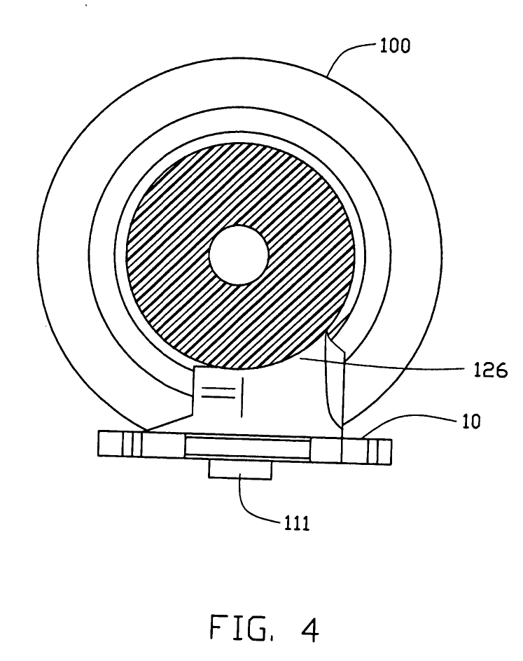

Taking reference to FIGS. 3-4, the contact 10 engages with a cylindrical plug pin 100 of a complementary connector (not shown) to transfer signals. The plug pin 100 plugs into the electrical connector to contact the contact 10 to achieve the engagement. When the contact 10 and the plug pin 100 are completely engaged, the curved portion 125 of the contact 10 resiliently abuts the mating portion 101 of the plug pin 100. The radius of mating portion 101 is equal to that of the curved portion 125. The arc-shaped portion 126 further partially embraces the surface of cylindrical plug pin 100. Therefore, the contacting portion 12 fitly contact the plug pin 100.

Referring to FIGS. 3-4, the plug pin 100 has the column-shaped configuration, and the contact 10 has glossy surface, so the plug pin 100 is inserted fluently. Thus the friction between the contact 10 and the plug pin 100 during the insertion is rather few, which makes the abrasions of the contact 10 and the plug pin 100 are lightened. Furthermore, when the plug pin 100 engages with the contact 10, the resilient portion 121 is pressed downward to produce upward forces which are perpendicular to the engaging surface. The perpendicular forces can hold the plug pin 100 in the contact 10 therefore lead to compact engagement. And since the contact 10 partially embraces the plug pin 100 in the transversal direction, the arc-shaped portion 126 touches the mating portion 101 which is just arc-line-shaped, so the perpendicular forces are in different directions that can retain the plug pin 100 in different directions. Therefore, the plug pin 100 are well retained and hold by the contact 10.

Of course, the contact 10 in the present invention can also has different length, width and radian as in different applications.

It is to be understood, however, that even though numerous characteristics and advantages of the present invention have been set fourth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

1-8. (canceled)

9. A contact for use with a connector comprising;
a retention portion for retaining to an insulative housing of the connector;
a contacting portion located beside the retention portion; and
a contacting area formed on a section of the contacting portion; wherein said contacting area is downwardly curved along front-to-back direction while upwardly curved along a transverse direction.

10. (canceled)

11. The contact as claimed in claim 9, wherein a peak line formed by downwardly curving along said front-to-back direction is essentially perpendicular to that formed by upwardly curving along said transverse direction.

12. A contact assembly for use with a connector comprising:
first and second contacts,
said first contact including:
a plate type retention portion for retaining the contact in a housing of the connector;
a contacting portion located beside said retention portion;
a contacting area formed on one section of the contacting portion and defining an upward contacting surface; and
said second contact defining a circular contacting region; wherein
said first contact and said second contact are mated with each other along an axial direction, and said contacting area is formed with an asymmetric arrangement relative to a central line of said first contact along said axial direction.

13. The contact assembly as claimed in claim 12, wherein the contacting area includes a first region by one side of the central line is larger than a second region by the other side of the central line under a condition that said first region is upwardly curved to compliantly grasp the circular contacting region of the second contact while the first region essentially not.

14. The contact assembly as claimed in claim 12, wherein the first contact defines a tail portion beside said retention portion and opposite to the contacting portion.

15. The contact assembly as claimed in claim 12, wherein the contact potion of the first contact defines a connection portion connecting the contact area and the retention portion.

16. The contact assembly as claimed in claim 15, wherein the connection portion is co-planar with the retention portion.

17. The contact assembly as claimed in claim 12, wherein retention portion has a retaining tab extends with a sharp angle relative to the plane thereof.
